(19) United States
(12) Patent Application Publication
(10) Pub. No.: US 2016/0200845 A1
(43) Pub. Date: Jul. 14, 2016

(54) CROSS-LINKED CO-POLYMERS FOR MAKING OPTOELECTRONIC DEVICES

(71) Applicant: Empire Technology Development LLC, Wilmington, DE (US)

(72) Inventors: William Brenden CARLSON, Seattle, WA (US); Gregory David PHELAN, Cortland, NY (US)

(21) Appl. No.: 14/912,725

(22) PCT Filed: Aug. 23, 2013
(86) PCT No.: PCT/US2013/056469

§ 371 Date: Feb. 18, 2016

(51) Int. Cl. C08F 220/18; G02F 1/00; C08J 3/24

(52) U.S. Cl. CPC C08F 220/18; C08J 3/247; G02F 1/0018; G02F 1/0072; C08J 2333/12

(57) ABSTRACT

Compositions, devices, and methods are provided regarding cross-linked co-polymers that include chromophores, where the chromophores are aligned so as to provide electro-optic activity to the cross-linked co-polymer.

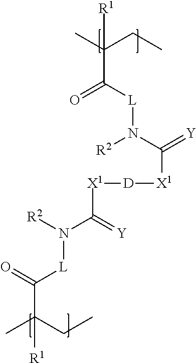

### FIELD

The present technology relates generally to the field of optoelectronics. In particular, compositions, devices, and methods are provided regarding cross-linked co-co-polymers that include chromophores, where the chromophores are aligned so as to provide electro-optic activity to the cross-linked co-polymer.

### BACKGROUND

Optoelectronics is a rapidly changing and emerging field based on the modulation of light through waveguides, such as fiber optic networks, and has been applied to many disciplines. The storage of information and telecommunications are two such disciplines; however, the technology has been applied to random access memory, motherboards, and central processing units.

Current technologies include the use of lithium niobate (LiNbO₃) crystals to impart the modulation of light. Lithium niobate flexes when an electric field is applied to the crystal. The change in configuration leads to a change in index of refraction which is used to modulate the light signals. Crystals can flex only so fast, so the overall bandwidth is limited to 10 GHz.

### SUMMARY

In one aspect, a cross-linked co-polymer is provided that includes a first repeating unit and a second repeating unit. The first repeating unit is represented as

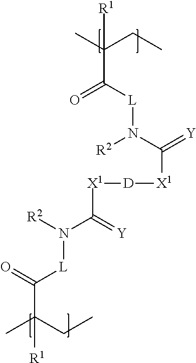

wherein X¹ is O, NR³, or S; Y is O, S, PH, P-alkyl, or P-aryl; R¹ is H, alkyl, cyano, or halo; R² is H, alkyl, or aryl; R³ is H or alkyl; L is a linking moiety; and D is a chromophore, wherein each X¹ is separated from the other by at least 10 atoms in the chromophore and at least two of the 10 atoms are part of a conjugated π-electron system.

In another aspect, an optoelectronic device is provided. The optoelectronic device includes a cross-linked co-polymer including a first and a second end; and a light source proximal to the first end of the co-polymer configured to illuminate light onto the first end such that the light propagates from the first end to the second end; wherein the cross-linked co-polymer includes a first repeating unit and a second repeating unit, wherein the first repeating unit is represented as

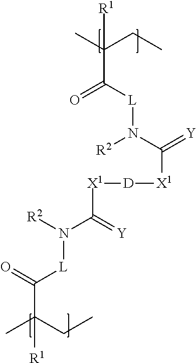

where X¹ is O, NR³, or S; Y is O, S, PH, P-alkyl, or P-aryl; R¹ is H, alkyl, cyano, or halo; R² is H, alkyl, or aryl; R³ is H or alkyl; L is a linking moiety; D is a chromophore, wherein each X¹ is separated from the other by at least 10 atoms in the chromophore and at least two of the 10 atoms are part of a conjugated n-electron system; and the optoelectronic device has a bandwidth of about 1 GHz to about 10 THz.

In another aspect, a method of producing a cross-linked co-polymer is provided. The method includes heating a film that includes a co-polymer and a cross-linker in the presence of an electric field; where the co-polymer includes a first repeating unit and a second repeating unit, where the first repeating unit is represented as

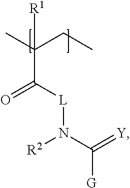

where Y is O, S, PH, P-alkyl, or P-aryl; R¹ is H, alkyl, cyano, or halo; R² is H, alkyl, or aryl; L is a linking moiety; and G is an O- or N-bound blocking group. In the method, the cross-linker is represented as

X²-D-X²

where X² is OH, NHR³, or SH; R³ is H or alkyl; D is a chromophore, each X² is separated from the other by at least 10 atoms in the chromophore and at least two of the 10 atoms are part of a conjugated π-electron system. Further, in the method, heating the co-polymer with the cross-linker in the presence of the electric field generates G-H.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Alkyl groups include straight chain, branched chain, or cyclic alkyl groups having 1 to 24 carbons or the number of carbons indicated herein. In some embodiments, an alkyl group has from 1 to 16 carbon atoms, from 1 to 12 carbons, from 1 to 8 carbons or, in some embodiments, from 1 to 6, or 1, 2, 3, 4 or 5 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. In some embodiments, the alkyl groups may be substituted alkyl groups.

Cycloalkyl groups are cyclic alkyl groups having from 3 to 10 carbon atoms. In some embodiments, the cycloalkyl group has 3 to 7 ring members, whereas in other embodiments the number of ring carbon atoms range from 3 to 5, 3 to 6, or 5, 6 or 7. Cycloalkyl groups further include monocyclic, bicyclic and polycyclic ring systems. Monocyclic groups include, e.g., cyclopropyl, cyclobutyl, cyclopentyl, cyclohexyl, and cycloheptyl groups. Bicyclic and polycyclic cycloalkyl groups include bridged or fused rings, such as, but not limited to, bicyclo[3.2.1]octane, decalinyl, and the like. Cycloalkyl groups include rings that are substituted with straight or branched chain alkyl groups as defined above. In some embodiments, the cycloalkyl groups are substituted cycloalkyl groups. Representative substituted alkenyl groups may be mono-substituted or substituted more than once, such as, but not limited to, mono-, di- or tri-substituted with substituents such as those listed above. Representative substituted alkyl groups may be mono-substituted or substituted more than once, such as, but not limited to, mono-, di- or tri-substituted with substituents such as those listed above.

Heterocyclyl groups are cycloalkyl groups as described above with the exception that at least one carbon of the ring carbon atoms is replaced by a heteroatom possessing the appropriate valence.

Alkenyl groups include straight and branched chain alkyl groups as defined above, except that at least one double bond exists between two carbon atoms. Thus, alkenyl groups have from 2 to 24 carbon atoms, and typically from 2 to 10 carbons or, in some embodiments, from 2 to 8, 2 to 6, or 2 to 4 carbon atoms. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. Representative substituted alkenyl groups may be mono-substituted or substituted more than once, such as, but not limited to, mono-, di- or tri-substituted with substituents such as those listed above.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Heteroaryl groups are cyclic aromatic groups that contain at least one heteroatom in the aromatic ring, including but not limited to pyridinyl groups, pyrazolyl groups, furanyl groups, triazolyl groups, and the like.

Aralkyl groups are alkyl groups substituted with aryl groups. Representative aralkyl groups include, but are not limited to, a phenylmethyl group, a 2-phenylethyl group, a 2-(4′-methoxyphenyl)ethyl group, and the like.

The terms “alkylene,” “cycloalkylene,” “alkenylene,” “arylene,” and “aralkylene,” alone or as part of another substituent means a divalent radical derived from an alkyl, cycloalkyl, alkenyl, aryl, or aralkyl group, respectively, as exemplified by —CH₂CH₂CH₂CH₂—. Thus, a “C₁-C₆ alkylene” describes methylene, ethylene, propylene, butylene, pentylene, and hexylene diradicals. For alkylene, cycloalkylene, alkenylene, arylene, and aralkylene linking groups, no orientation of the linking group is implied. For example, a “C₁-C₃ alkylene” includes a methylene diradical, a 1,2 ethylene diradical, a 1,1-ethylene diradical, a 1,3-propylene diradical, a 1,2-propylene diradical, and a 1,1-propylene diradical. A “phenylene” group includes a 1,2-phenylene diradical, a 1,3-phenylene diradical, and a 1,4-phenylene diradical.

Haloallcyl groups include alkyl groups as defined above in which 1 or more of the hydrogen atoms are replaced by a halogen (i.e., F, Cl, Br, or I). In some embodiments the haloalkyl group bears from 1 to 3 halogens. In others, the haloalkyl is perhalogenated such as perfluorinated or perchlorinated. Examples of haloalkyl groups include but are not limited to —CH₂Cl, —CH₂F, —CF₃, —CH₂CH₂Br, and —CH₂CF₃.

The term “amine” (or “amino”) as used herein refers to —NHR and —NRR′ groups, wherein R, and R′ are independently hydrogen, or a substituted or unsubstituted alkyl, alkenyl, alkynyl, cycloalkyl, aryl or aralkyl group as defined herein. Examples of amino groups include —NH₂, methylamino, dimethylamino, ethylamino, diethylamino, propylamino, isopropylamino, phenylamino, benzylamino, and the like.

A “cyano” group is synonymous with a nitrile group and refers to —C═N.

The term “oxo” refers to a divalent oxygen group. While the term includes doubly bonded oxygen, such as that found in a carbonyl group, as used herein, the term oxo explicitly includes singly bonded oxygen of the form —O— which is part of a polymer backbone. Thus, an oxo group may be part of an ether linkage (—O—), an ester linkage (—O—C(O)—), a carbonate linkage (—O—C(O)O—), a carbamate linkage (—O—C(O)NH— or —O—C(O)NR—), and the like.

“Substituted” refers to a chemical group as described herein that further includes one or more substituents, such as lower alkyl (including substituted lower alkyl such as haloalkyl, hydroxyalkyl, aminoalkyl), aryl (including substituted aryl), acyl, halogen, hydroxy, amino, alkoxy, alkylamino, acylamino, thioamide, acyloxy, aryloxy, aryloxyalkyl, carboxy, thiol, sulfide, sulfonyl, oxo, both saturated and unsaturated cyclic hydrocarbons (e.g., cycloalkyl, cycloalkenyl), cycloheteroalkyls and the like. These groups may be attached to any carbon or substituent of the alkyl, alkenyl, alkynyl, aryl, cycloheteroalkyl, alkylene, alkenylene, alkynylene, arylene, hetero moieties. Additionally, the substituents may be pendent from, or integral to, the carbon chain itself.

The term “blocking group” refers to a molecule that is bonded to a functional group to prevent the functional group from reacting with undesired molecules. “De-blocking” means removal of the blocking group. De-blocking includes subjecting the blocked functional group to conditions that promote elimination of the blocking group as a protonated molecule and/or nucleophilic displacement of the blocking group by a nucleophile. Nucleophilic displacements may be acid-catalyzed or base-catalyzed. When de-blocking involves elimination of the blocking group, a de-blocked moiety is generated. For example, the compound 2-(3,4-dimethyl-1H-pyrazole-1-carboxamido)ethyl methacrylate is considered a molecule with a blocking group (i.e. a “blocked compound”) where the blocking group is the N-bound 3,4-dimethyl-1H-pyrazole group. De-blocking 2-(3,4-dimethyl-1H-pyrazole-1-carboxamido)ethyl methacrylate by elimination of the blocking group provides the de-blocked compound 2-isocyanatoethyl methacrylate.

A “block co-polymer” will be understood by persons of ordinary skill in the art. If there are uses of the term which are not clear to persons of ordinary skill in the art, the term shall refer to two or more different homopolymer subunits linked by covalent bonds.

In an effort to overcome the limitations imposed by optoelectronic systems, for example optoelectronic systems that are based on crystal flex, the present technology utilizes organic polymeric materials that incorporate chromophores. Electron density travels back and forth along the chromophore when an electric field is applied. The change in electron density along the chromophore backbone may lead to a change in index of refraction. The change in index of refraction may be used to modulate the light of a fiber optic network, and thus may have applications in optoelectronic devices. Electron density can change much faster than a crystal can flex, hence an overall bandwidth may increase to over 10 THz.

The chromophores in such polymeric materials may be oriented in the proper direction for the polymeric materials to function correctly. Orientation of the chromophores may be accomplished through poling. As chromophores are polar molecules, in theory, chromophores will orient when a strong electric field is applied. When oriented, it is important to lock the orientation of the chromophores into place in order to ensure optimal optoelectronic activity.

The present technology provides compositions, devices, and methods regarding cross-linked co-co-polymers that include chromophores. According to the present technology, the cross-linkers of the cross-linked co-polymer may include the chromophores. The chromophores may be poled prior to cross-linking the polymer. Upon attaining the proper alignment, the cross-linkers then cross-link the polymer. Thus, upon cross-linking the co-polymer, the chromophores are locked in the correct orientation to provide opto-electronic activity.

In one embodiment, a cross-linked co-polymer may include a first repeating unit and a second repeating unit. The first repeating unit may be represented as

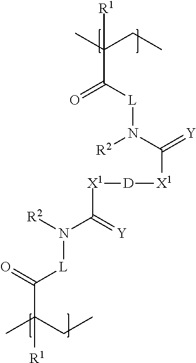

where X¹ is O, NR³, or S; Y is O, S, PH, P-alkyl, or P-aryl; R¹ is H, alkyl, cyano, or halo; R² is H, alkyl, or aryl; R³ is H or alkyl; L is a linking moiety; and D is a chromophore, where each X¹ is separated from the other by at least 10 atoms in the chromophore and at least two of the 10 atoms are part of a conjugated π-electron system. The number of atoms that are part of the conjugated π-electron system may be at least three, at least four, at least five, at least six, at least seven, at least eight, at least nine, or at least ten of the at least 10 atoms in the chromophore that are separating each X¹ from each other. The number of atoms in the chromophore that are separating each X¹ from each other may be at least 11, at least 12, at least 13, at least 14, at least 15, at least 16, at least 17, at least 18, at least 19, at least 20, at least 21, at least 22, at least 23, at least 24, or at least 25. In some embodiments, Y is O. In some embodiments, X¹ is O. In some embodiments, R¹ is H, methyl, ethyl, cyano, fluoro, or chloro. In some embodiments, R² is H, methyl, ethyl, propyl, a substituted phenyl, or an unsubstituted phenyl. In some embodiments, R³ is H, methyl, ethyl, propyl, butyl, pentyl, hexyl, heptyl, or octyl. The cross-linked co-polymer may be a random co-polymer, an alternating co-polymer, or a block-co-polymer. In some embodiments, the cross-linked co-polymer is a random co-polymer. Where the cross-linked co-polymer is a random co-polymer, the cross-linked co-polymer is not a block co-polymer. Instead, the cross-linked co-polymer is in a single phase.

In typical lithium niobate systems, bandwidth may be limited by the fact that lithium niobate crystals physically flex to cause the change in the index of refraction. Lithium niobate systems are thus limited to an upper limit of about 10 gigahertz (GHz). However, the cross-linked co-polymer of the present technology does not rely on physical flexing in order to change the index of refraction. Without being bound by theory, the cross-linked co-polymers of the present technology are believed to function by the movement of electron density, allowing for a bandwidth of up to 5 terahertz (THz). Thus, in some embodiments, the bandwidth of the cross-linked co-polymer in changing the index of refraction of the cross-linked co-polymer in response to an electric field is greater than 10 GHz. The bandwidth of the cross-linked co-polymer may be about 50 GHz, about 100 GHz, about 150 GHz, about 200 GHz, about 250 GHz, about 300 GHz, about 400 GHz, about 500 GHz, about 600 GHz, about 700 GHz, about 800 GHz, about 1 THz, about 2 THz, about 3 THz, about 4 THz, about 5 THz, about 6 THz, about 7 THz, about 8 THz, about 9 THz, or any range including and between any two of these values or greater than any one of these values.

In some embodiments, L as disposed from the carbonyl carbon to the nitrogen is —alkylene-, —O-alkylene-, —NR⁴-alkylene-, -heterocyclylene-, —O-heterocyclylene-, —NR⁴-heterocyclylene-, -arylene-, —O-arylene-, —NR⁴-arylene-, -heteroarylene-, —O-heteroarylene-, or —NR⁴-heteroarylene-; where R⁴ is H, alkyl, or aryl. In some embodiments, L as disposed from the carbonyl carbon to the nitrogen is —(C₁-C₆ alkylene)-, —O—(C₁-C₆ alkylene)-, —NR⁴—(C₁-C₆ alkylene)-, -arylene-, —O-arylene-, —NR⁴-arylene-, -heteroarylene-, —O-heteroarylene-, or —NR⁴-heteroarylene-; where R⁴ is H, alkyl, or aryl. In some embodiments, R⁴ is H, methyl, ethyl, propyl, a substituted phenyl, or an unsubstituted phenyl. In certain embodiments, L as disposed from the carbonyl carbon to the nitrogen is —O-ethylene-, —O-propylene-, or —O-butylene-.

In some embodiments, the second repeating unit is derived from a styrenic monomer, an acrylate monomer, a cyanoacrylate monomer, an acrylamide monomer, or an olefinic monomer. In some embodiments, the second repeating unit is derived from styrene, deuterated styrene, fluorinated styrene, methyl acrylate, ethyl acrylate, propyl acrylate, butyl acrylate, 1-adamantyl acrylate, isobornyl acrylate, trifluoromethyl acrylate, pentafluoroethyl acrylate, heptafluoropropyl acrylate, nonafluorobutyl acrylate, trideuteromethyl acrylate, pentadeuteroethyl acrylate, heptadeuteropropyl acrylate, nonadeuterobutyl acrylate, methyl methacrylate, ethyl methacrylate, propyl methacrylate, butyl methacrylate, 1-adamantyl methacrylate, isobornyl methacrylate, trifluoromethyl methacrylate, pentafluoroethyl methacrylate, heptafluoropropyl methacrylate, nonafluorobutyl methacrylate, trideuteromethyl methacrylate, pentadeuteroethyl methacrylate, heptadeuteropropyl methacrylate, nonadeuterobutyl methacrylate, 2-(ethyl-[4-(4-nitro-phenylazo)-phenyl]-amino)-ethyl methacrylate, maleic anhydride, ethylene, propylene, tetrafluoroethylene, hexafluoropropylene, fluorinated styrene, deuterated ethylene, deuterated propylene, vinyl chloride, vinyl acetate, vinyl pyridine, vinyl naphthalene, vinylidene chloride, or vinylidene fluoride.

In some embodiments, the chromophore is polar. In some embodiments, the chromophore possesses at least a dipole moment. Incorporation of a dipole moment may allow for at least 2^{nd} order non-linear optic activity of the chromophores. Electron density travels back and forth along the chromophore when an electric field is applied. This change in electron density along the chromophore backbone may lead to a change in index of refraction of the cross-linked co-polymer. This change in index of refraction may be used, for example, to modulate the light of a fiber optic network. In some embodiments, the chromophore may possess 3^{rd} order non-linear optic activity. In some embodiments, the chromophore may possess 4^{th} order non-linear optic activity. The chromophore may possess a multipole moment, including but not limited to, a quadropole moment, a hexapole moment, an octopole moment, as well as greater multipole moments.

In some embodiments, the chromophore is represented by one of the following formulas:

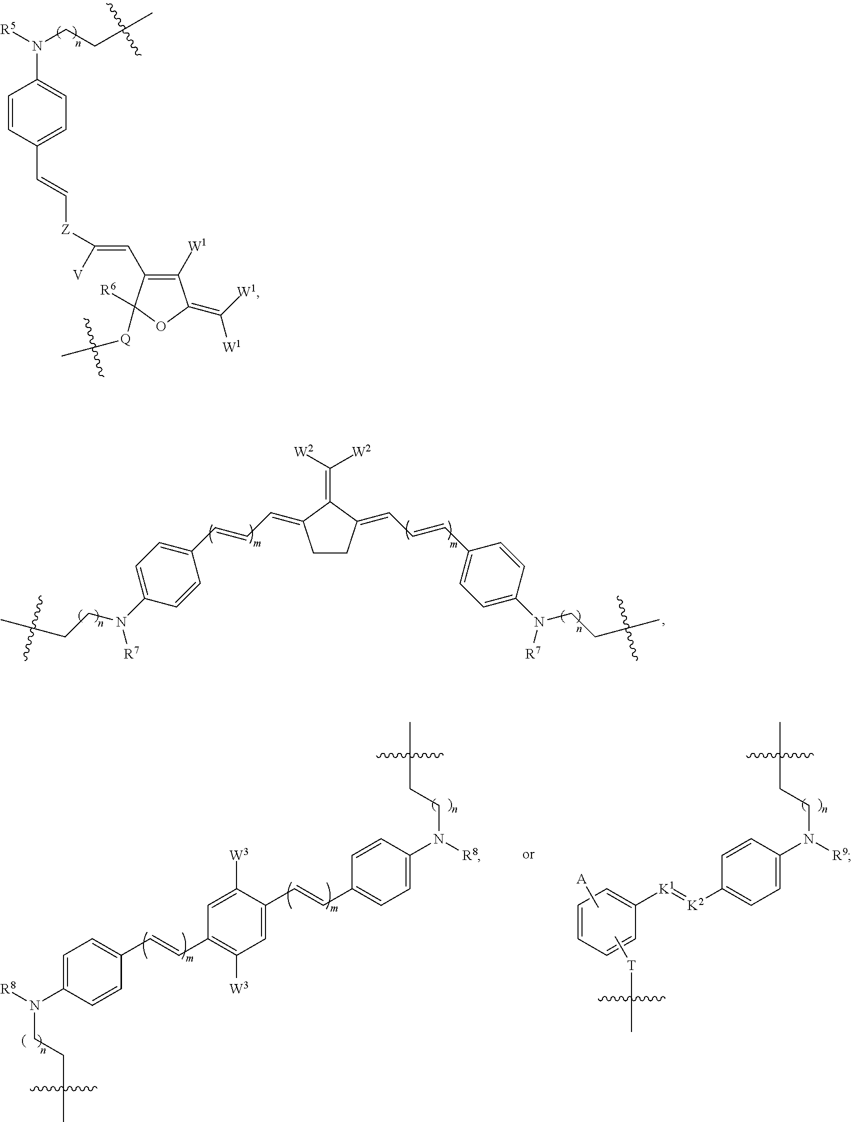

where R⁵, R⁷, R⁸ and R⁹ are each independently alkyl or aryl; R⁶ is alkyl, perhaloalkyl, aryl, or aralkyl; Z is alkenylene, arylene, or heteroarylene; V is H or an alkylene group bonded to Z; Q is alkylene, arylene, or aralkylene; K¹ and K² are each independently CH or N; T is alkylene or arylene, and T is in an ortho or a meta position on the ring with respect to the bond to K; A is cyano, nitro, CF₃, or

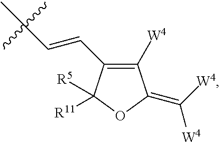

where R¹¹ is alkyl, perhaloalkyl, aryl, or aralkyl; and A is in a para or an ortho position on the ring with respect to the bond to K¹; W¹, W², W³, and W⁴ are each independently cyano, perhaloalkyl, CO₂R¹⁰, SO₂R¹⁰, S(O)(OR¹⁰)₂, P(O)(OR¹⁰)₂; R¹⁰ is alkyl or perhaloalkyl; n is 1, 2, 3, 4, 5, 6, 7, 8, 10, or 11; and m is 1, 2, 3, or 4. In some embodiments, T is in a meta position with respect to the bond to K¹. In some embodiments, K² is CH. In some embodiments, K¹ and K² are both N. In some embodiments, n is 1, 2, 3, or 4. In some embodiments, R⁵, R⁷, R⁸ and R⁹ are each independently alkyl. In some embodiments, R⁵, R⁷, R⁸ and R⁹ are each independently methyl, ethyl, propyl, butyl, pentyl, hexyl, heptyl, or octyl. In some embodiments, R⁶ is methyl, CF₃, or p-methoxyphenyl. In some embodiments, Q is —CH₂-Ph-. In some embodiments, R¹¹ is methyl, CF₃, or p-methoxyphenyl. In some embodiments, W¹, W², W³, and W⁴ are each independently cyano, CF₃, CF₂CF₃, CO₂Me, CO₂Et, SO₂CF₃, SO₂Ph, S(O)(OPhCH₃)₂, P(O)(OCH₃)₂, P(O)(OCF₃)₂, P(O)(OPh)₂, or P(O)(OPhCH₃)₂. In some embodiments, R⁹ is methyl, ethyl, propyl, butyl, pentyl, hexyl, heptyl, or octyl. In some embodiments, R⁹ is C₁-C₆ alkyl; K¹ and K² are both N; A is p-cyano, p-nitro, or p-CF₃; T is methylene, ethylene, propylene, or butylene; and n is 1, 2, 3, or 4.

In certain embodiments, the chromophore is

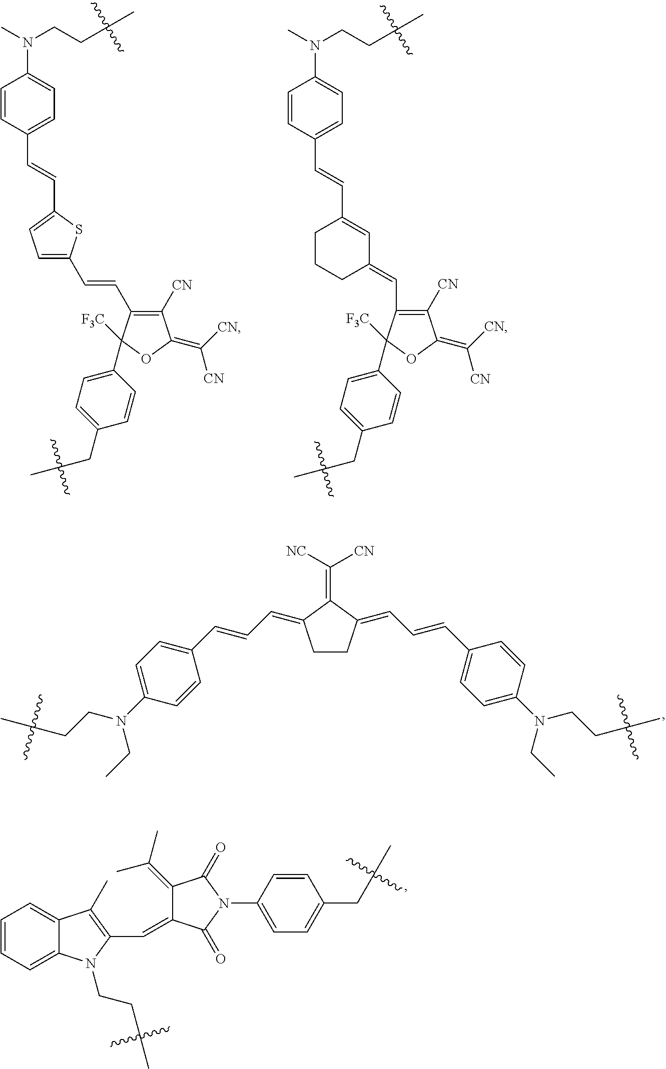 [SMILES: *CCN(C)c1ccc(/C=C/c2ccc(/C=C/C3=C(C#N)C(=C(C#N)C#N)OC3(c3ccc(C*)cc3)C(F)(F)F)s2)cc1 ; *CCN(C)c1ccc(/C=C/C2=CC(=C/C3=C(C#N)C(=C(C#N)C#N)OC3(c3ccc(C*)cc3)C(F)(F)F)/CCC2)cc1 ; *CCN(CC)c1ccc(/C=C/C=C2\CC/C(=C\C=C\c3ccc(N(CC)CC*)cc3)C2=C(C#N)C#N)cc1 ; *CCn1c(/C=C2/C(=O)N(c3ccc(C*)cc3)C(=O)C2=C(C)C)c(C)c2ccccc21]

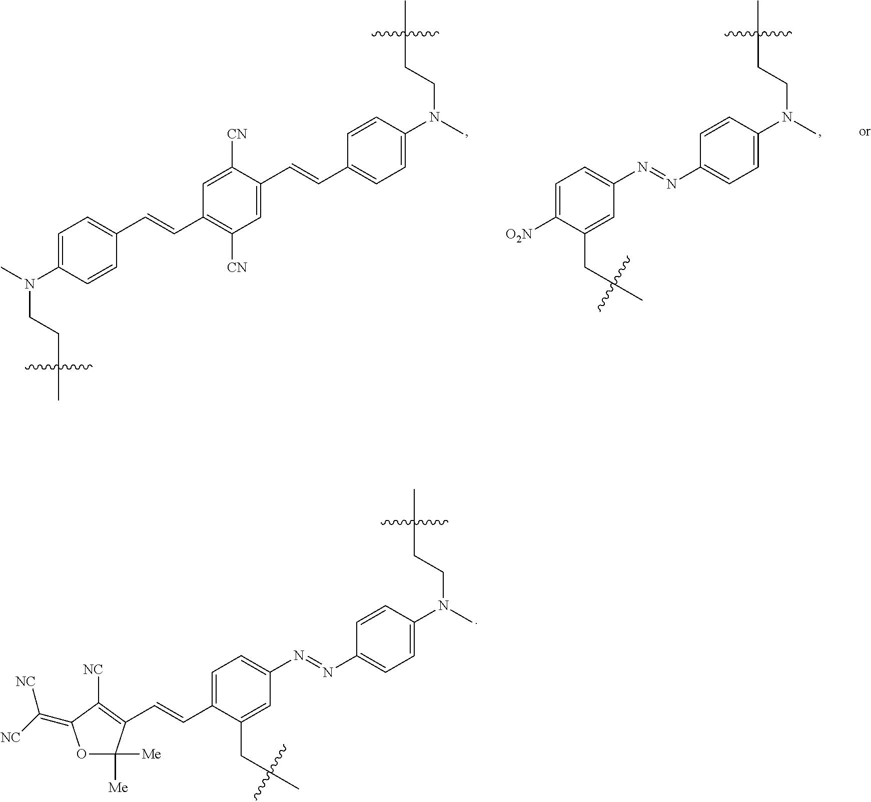

In another embodiment, an optoelectronic device is provided. The optoelectronic device may include a cross-linked co-polymer that includes a first and a second end; and a light source proximal to the first end of the co-polymer configured to illuminate light onto the first end such that the light propagates from the first end to the second end. The optoelectronic device may be an optical interferometer such as an optical fiber interferometer. For example, the cross-linked co-polymer may be used as an optical fiber in the device to provide an optical path. As the optical path length may change according to changes in parameters such as temperature, pressure, or mechanical strain, the device may be used as a sensor for sensing changes in these parameters. In the optoelectronic device, the cross-linked co-polymer is configured to transmit light from the first end to the second end. A portion of the cross-linked co-polymer may be split into a first branch and a second branch and subsequently rejoined. A portion of the first branch can be attached to two electrodes that span the diameter of the first branch. The cross-linked co-polymer may include any one of the cross-linked co-polymers as described in the above embodiments. In some embodiments, the optoelectronic device includes a detector proximal to the second end of the co-polymer configured to receive the light that exits from the second end. The optoelectronic device may have a bandwidth of about 1 gigahertz (GHz) to about 10 terahertz (THz). The bandwidth of the optoelectronic device may be about 5 GHz, about 10 GHz, about 50 GHz, about 100 GHz, about 150 GHz, about 200 GHz, about 250 GHz, about 300 GHz, about 400 GHz, about 500 GHz, about 600 GHz, about 700 GHz, about 800 GHz, about 1 THz, about 2 THz, about 3 THz, about 4 THz, about 5 THz, about 6 THz, about 7 THz, about 8 THz, about 9 THz, or any range including and between any two of these values or greater than any one of these values.

In another embodiment, a method of producing a cross-linked co-polymer is provided. The method may include heating a film that includes a co-polymer and a cross-linker in the presence of an electric field. The co-polymer of the method may include a first repeating unit and a second repeating unit, where the first repeating unit is represented as

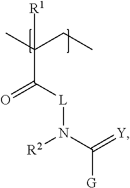

where Y is O, S, PH, P-alkyl, or P-aryl; R¹ is H, alkyl, cyano, or halo; R² is H, alkyl, or aryl; L is a linking moiety; and G is an O- or N-bound blocking group. The co-polymer may be a random co-polymer, an alternating co-polymer, or a block-co-polymer. In some embodiments, the co-polymer is a random co-polymer. In some embodiments, R¹ is H, methyl, ethyl, cyano, fluoro, or chloro. In some embodiments, R² is H, methyl, ethyl, propyl, a substituted phenyl, or an unsubstituted phenyl.

The cross-linker of the method may be represented as

X²-D-X²

where X² is OH, NHR³, or SH; R³ is H or alkyl; D is a chromophore, each X² is separated from the other by at least 10 atoms in the chromophore and at least two of the 10 atoms are part of a conjugated π-electron system; and heating the co-polymer with the cross-linker in the presence of the electric field generates G-H. The number of atoms that are part of the conjugated π-electron system may be at least three, at least four, at least five, at least six, at least seven, at least eight, at least nine, or at least ten of the at least 10 atoms in the chromophore that are separating each X² from each other. The number of atoms in the chromophore that are separating each X² from each other may be at least 11, at least 12, at least 13, at least 14, at least 15, at least 16, at least 17, at least 18, at least 19, at least 20, at least 21, at least 22, at least 23, at least 24, or at least 25. In some embodiments, Y is O. In some embodiments, X² is OH. In some embodiments, R³ is H, methyl, ethyl, propyl, butyl, pentyl, hexyl, heptyl, or octyl.

By providing co-polymers and cross-linkers in this fashion, the chromophore may be aligned properly in the presence of the electric field to produce the electro-optic effect. Subsequent reaction of the cross-linker with the co-polymer locks in the proper alignment of the chromophore. The method may produce any of the previously described cross-linked co-polymers of the present technology. In some embodiments, the co-polymer and the cross-linker are miscible.

In some embodiments of the method, G-H is an alkyl alcohol, an aryl alcohol, an imidazole, a pyrazole, a triazole, a tetrazole, an imide, a β dicarbonyl compound, a β-cyano carbonyl compound, a pyrrolidine, a morpholine, a thiomorpholine, a pyridine, a piperidine, or a combination of any two or more thereof.

In some embodiments, G-H is methanol, ethanol, n-propanol, i-propanol, imidazole, 2-mercaptoimidazole, 2-aminoimidazole, 2-methylimidazole, 4-methylimidazole, 2-ethylimidazole, 2-mercapto-l-methylimidazole, 3-methylpyrazole, 4-methylpyrazole, 3,4-dimethylpyrazole, 3,5-dimethylpyrazole, 3-cyanopyrazole, 4-cyanopyrazole, 1,2,4-triazole, 1H-1,2,4-triazole-3-thiol, 4H-1,2,4-triazol-3-amine, 3-methyl-1,2,4-triazole, 3-cyano-1,2,4-triazole, 3,5-dimethyl-1,2,4-triazole, 1,2,3-triazole, 4-methyl-1,2,3-triazole, 4,5-dimethyl-1,2,3-triazole, 1H-benzo[d][1,2,3]triazole, 1H-1,2,3-triazolo[4,5-b]pyridine, 1H-tetrazole, 5-methyl-1H-tetrazole, succinimide, glutarimide, phthalimide, acetylacetone, cyclohexane-1,3-dione, methyl acetoacetate, ethylacetoacetate, dimethyl malonate, diethylmalonate, 1,3-dioxane-4,6-dione, 3-oxobutanenitrile, methyl 2-cyanoacetate, ethyl 2-cyanoacetate, pyrrolidine, 2-methylpyrrolidine, 3-methylpyrrolidine, morpholine, 2-methylmorpholine, 2,2-dimethylmorpholine, 2,5-dimethylmorpholine, 2,2,5,5-tetramethylmorpholine, pyridine, 3-piperidone, 4-piperidone, 2-cyanopyridine, 4-cyanopyridine, 2-methylpyridine, 4-methylpyridine, 2,6-dimethylpyridine, piperidine, 2-aminopiperidine, 3-aminopiperidine, 3-fluoropiperidine, 4-fluoropiperidine, 3,3-difluoropiperidine, 4,4-difluoropiperidine, 2-methylpiperidine, 3-methylpiperidine, or a combination of any two or more thereof.

In some embodiments, L as disposed from the carbonyl carbon to the nitrogen is —alkylene-, —O-alkylene-, —NR⁴-alkylene-, -heterocyclylene-, —O-heterocyclylene-, —NR⁴-heterocyclylene-, -arylene-, —O-arylene-, —NR⁴-arylene-, -heteroarylene-, —O-heteroarylene-, or —NR⁴-heteroarylene-; where R⁴ is H, alkyl, or aryl. In some embodiments, L as disposed from the carbonyl carbon to the nitrogen is —(C₁-C₆ alkylene)-, —O—(C₁-C₆ alkylene)-, —NR⁴—(C₁-C₆ alkylene)-, -arylene-, —O-arylene-, —NR⁴-arylene-, -heteroarylene-, —O-heteroarylene-, or —NR⁴-heteroarylene-; where R⁴ is H, alkyl, or aryl. In some embodiments, L as disposed from the carbonyl carbon to the nitrogen is —O-ethylene-, —O-propylene-, or —O-butylene-. In some embodiments, R⁴ is H, methyl, ethyl, propyl, a substituted phenyl, or an unsubstituted phenyl.

In some embodiments, the second repeating unit is derived from a styrenic monomer, an acrylate monomer, a cyanoacrylate monomer, an acrylamide monomer, or an olefinic monomer. In some embodiments, the second repeating unit is derived from styrene, deuterated styrene, fluorinated styrene, methyl acrylate, ethyl acrylate, propyl acrylate, butyl acrylate, 1-adamantyl acrylate, isobornyl acrylate, triflubromethyl acrylate, pentafluoroethyl acrylate, heptafluoropropyl acrylate, nonafluorobutyl acrylate, trideuteromethyl acrylate, pentadeuteroethyl acrylate, heptadeuteropropyl acrylate, nonadeuterobutyl acrylate, methyl methacrylate, ethyl methacrylate, propyl methacrylate, butyl methacrylate, 1-adamantyl methacrylate, isobornyl methacrylate, trifluoromethyl methacrylate, pentafluoroethyl methacrylate, heptafluoropropyl methacrylate, nonafluorobutyl methacrylate, trideuteromethyl methacrylate, pentadeuteroethyl methacrylate, heptadeuteropropyl methacrylate, nonadeuterobutyl methacrylate, 2-(ethyl-[4-(4-nitro-phenylazo)-phenyl]-amino)-ethyl methacrylate, maleic anhydride, ethylene, propylene, tetrafluoroethylene, hexafluoropropylene, fluorinated styrene, deuterated ethylene, deuterated propylene, vinyl chloride, vinyl acetate, vinyl pyridine, vinyl naphthalene, vinylidene chloride, or vinylidene fluoride.

In some embodiments, the method further includes depositing the film onto a substrate prior to heating. In some embodiments, the substrate is conductive. Conductive substrates may include glass with at least a portion of a surface coated with a conductive substance. The conductive substance may include, but is not limited to, indium tin oxide, titanium nitride, zinc oxide, zinc sulfide, zinc indium tin oxide, aluminum zinc oxide, cadmium oxide, or mixtures of any two or more thereof. In some embodiments, the depositing step includes spin coating a solution onto the substrate to produce the film, where the solution includes the co-polymer and the cross-linker. In such embodiments, the film may be from about 0.001 μm to about 100 μm thick. The film may have a thickness of about 0.01 μm, about 0.05 μm, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 70 μm, about 80 μm, about 90 μm, and any range including and between any two of these values or above any one of these values. In such embodiments, the solution may include an aprotic solvent. The aprotic solvent may include ethylene carbonate, dimethylcarbonate, diethylcarbonate, propylene carbonate, dioxolane, dimethyl ether, diethyl ether, tetrahydrofuran (THF), acetonitrile, acetone, butanone, pentanone, cyclopentanone, hexanone, cyclohexanone, benzene, toluene, methylene chloride, dichloroethane, 1,1,1,-trichloroethane, 1,1,2-trichloroethane, chlorobenzene, chlorotoluene, and dichlorobenzene. In embodiments including spin coating, the solution may further include a surfactant. The surfactant may be included to provide smooth surfaces of the films to enhance the ability of the films to waveguide. Appropriate surfactants are well known to those of skill in the art, as are the procedures for determining the appropriate amount of surfactants to include in the solution to produce the desired film.

In some embodiments, the heating occurs at a temperature of about 80° C. to about 400° C. In some embodiments, the heating occurs at a temperature of about 120° C. to about 200° C. The temperature may be about 90° C., about 100° C., about 120° C., about 140° C., about 160° C., about 180° C., about 200° C., about 220° C., about 240° C., about 260° C., about 280° C., about 300° C., about 320° C., about 340° C., about 360° C., about 380° C., and any range including and in between any two of these values or above any one of these values.

In some embodiments, the electric field is applied by a contact poling or a corona discharge. In some embodiments, the contact poling voltage is a direct current voltage of about 0.1 V/μm to about 300 V/μm. The contact poling voltage may be a direct current voltage of about 0.5 V/μm, 1 V/μm, about 5 V/μm, about 10 V/μm, about 15 V/μm, about 20 V/μm, about 25 V/μm, about 30 V/μm, about 35 V/μm, about 40 V/μm, about 45 V/μm, about 50 V/μm, about 55 V/μm, about 60 V/μm, about 70 V/μm, about 80 V/μm, about 90 V/μm, about 100 V/μm, about 120 V/μm, about 140 V/μm, about 160 V/μm, about 180 V/μm, about 200 V/μm, about 220 V/μm, about 240 V/μm, about 260 V/μm, about 280 V/μm, or any range including and between any two of these values or above any one of these values. In some embodiments, the corona discharge is a positive discharge. In some embodiments, the corona discharge is about +5 kV to about +30 kV. The corona discharge may be about +6 kV, about +7 kV, about +8 kV, about +9 kV, about +10 kV, about +12 kV, about +14 kV, about +16 kV, about +18 kV, about +20 kV, about +22 kV, about +24 kV, about +26 kV, about +28 kV, or any range including and between any two of these values or above any one of these values. In some embodiments, the corona discharge may be achieved through a needle, a wire, or a mesh. In such embodiments, the needle, wire, or mesh screen may be steel, copper, tungsten, gold, platinum, iridium, rhodium, palladium, silver, cobalt, nickel, or combinations of any two or more thereof.

In some embodiments, the chromophore is polar. As discussed previously, the chromophore may possess at least a dipole moment. The chromophore may possess a multipole moment, including, but not limited to, a quadropole moment, a hexapole moment, an octopole moment, as well as greater multipole moments. The chromophore may exhibit 2^{nd} order non-linear optic activity, 3^{rd} order non-linear optic activity, and/or 4^{th} order non-linear optic activity. In some embodiments, the cross-linker is represented by one of the following formulas:

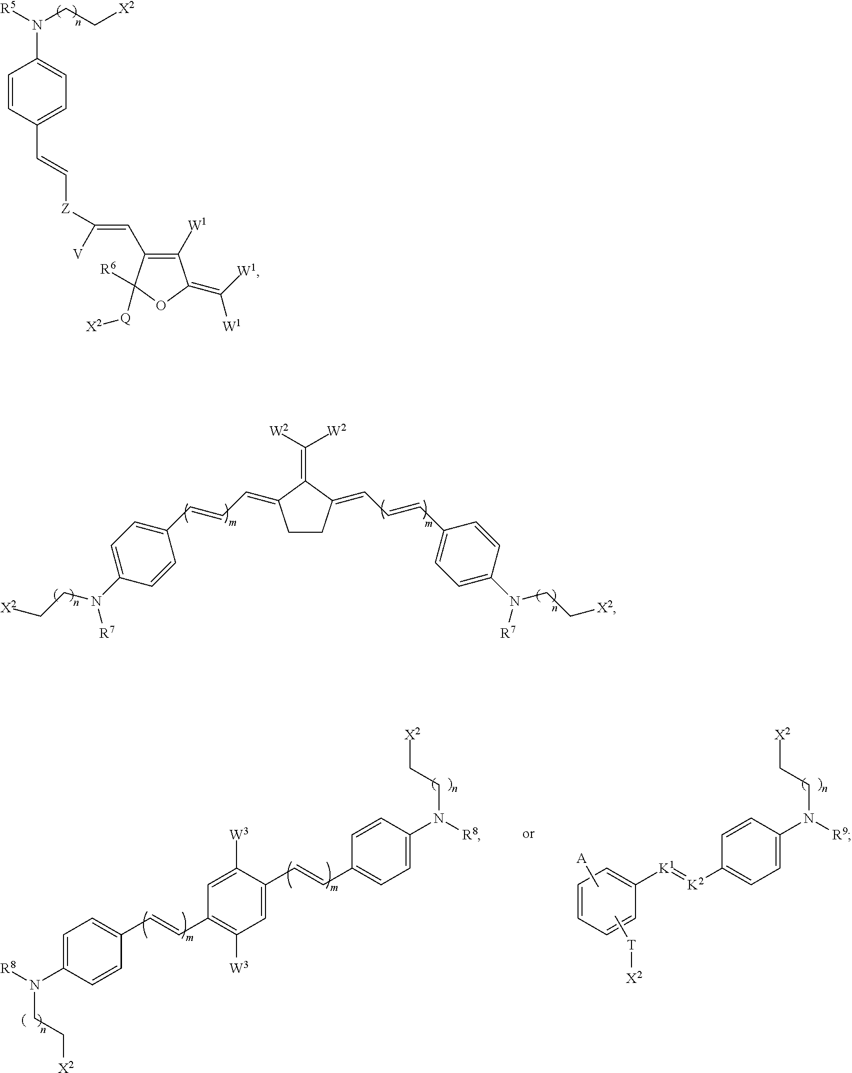

where R⁵, R⁷, R⁸ and R⁹ are each independently alkyl or aryl; R⁶ is alkyl, perhaloalkyl, aryl, or aralkyl; Z is alkenylene, arylene, or heteroarylene; V is H or an alkylene group bonded to Z; Q is alkylene, arylene, or aralkylene; K¹ and K² are each independently CH or N; T is alkylene or arylene, and T is in an ortho or a meta position on the ring with respect to the bond to K; A is cyano, nitro, CF₃, or

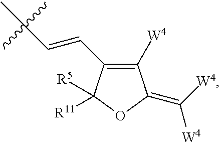

where R¹¹ is alkyl, perhaloalkyl, aryl, or aralkyl; and A is in a para or an ortho position on the ring with respect to the bond to K¹; W¹, W², W³, and W⁴ are each independently cyano, perhaloalkyl, CO₂R¹⁰, SO₂R¹⁰,)S(O)(OR¹⁰)₂, P(O)(OR¹⁰)₂; R¹⁰ is alkyl or perhaloalkyl; n is 1, 2, 3, 4, 5, 6, 7, 8, 10, or 11; and m is 1, 2, 3, or 4. In some embodiments, T is in a meta position with respect to the bond to K¹. In some embodiments, K² is CH. In some embodiments, K1 and K² are both N. In some embodiments, n is 1, 2, 3, or 4. In some embodiments, R⁵, R⁷, R⁸ and R⁹ are each independently alkyl. In some embodiments, R⁶ is methyl, CF₃, or p-methoxyphenyl. In some embodiments, Q is —CH₂-Ph-. In some embodiments, R¹¹ is methyl, CF₃, or p-methoxyphenyl. In some embodiments, W¹, W², W³, and W⁴ are each independently cyano, CF₃, CF₂CF₃, CO₂Me, CO₂Et, SO₂CF₃, SO₂Ph, S(O)(OPhCH₃)₂, P(O)(OCH₃)₂, P(O)(OCF₃)₂, P(O)(OPh)₂, or P(O)(OPhCH₃)₂. In some embodiments, m is 1 and W² is cyano. In some embodiments, R⁹ is C₁-C₆ alkyl; K¹ and K² are both N; A is p-cyano, p-nitro, or p-CF₃; T is methylene, ethylene, propylene, or butylene; and n is 1, 2, 3, or 4.

In some embodiments, the cross-linker is

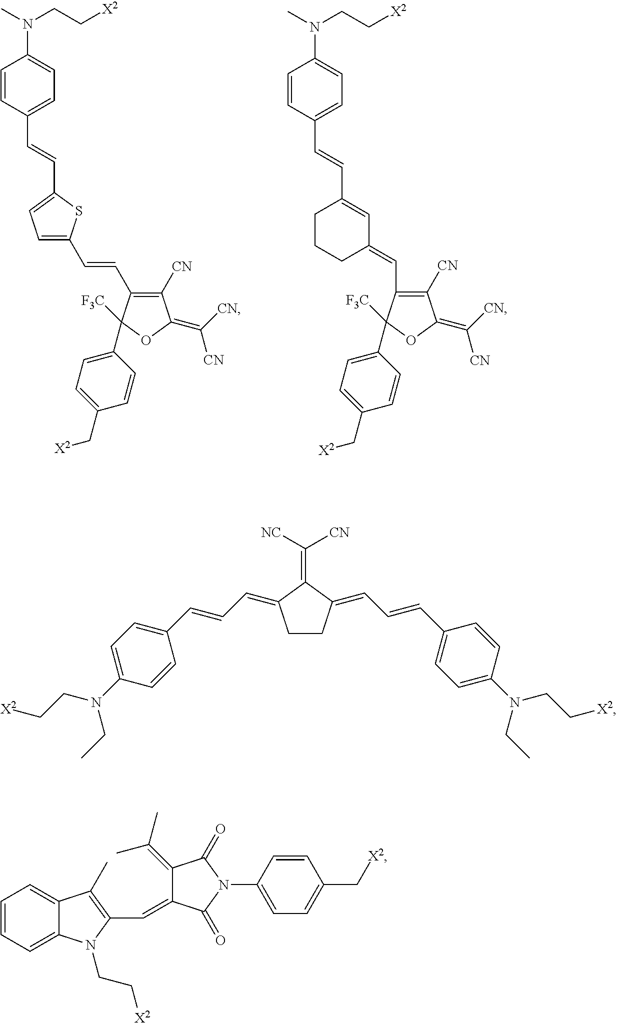

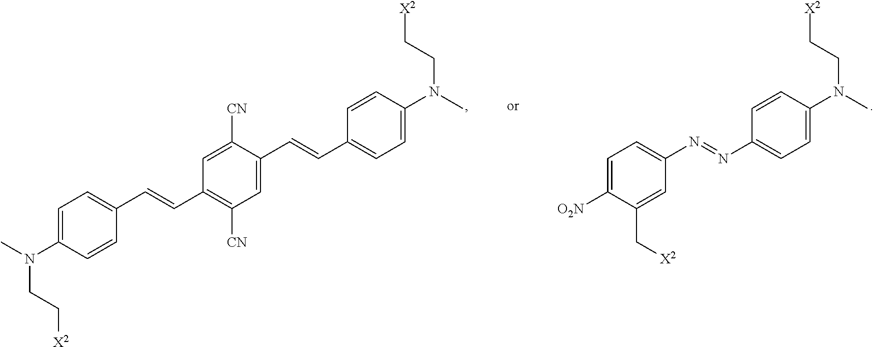

In some embodiments, the method further includes polymerizing a mixture of monomers to produce the co-polymer, where at least a portion of the monomers are represented by the following formula

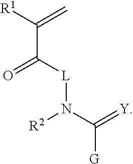

In such embodiments, G-H may be removed during the heating step by evaporation, sublimation, or a combination thereof. In such embodiments, the co-polymer may be a random co-polymer. In such embodiments, the polymerizing step may include a polymerization initiator. Polymerization initiators are well known to one of skill in the art and include, but are not limited to, benzoyl peroxide, ammonium persulfate, azobisisobutyronitrile (2,2′-azobis(2-methyl propionitrile); “AIBN”), lauroyl peroxide, 2-hydroxy-2-methylpropiophenone, benzophenone, bezoin, tert-butyl peroxide, dicumyl peroxide, tert-butyl cumyl peroxide or mixtures of any two or more thereof.

Thus, in such embodiments, the method of the present technology allows for the formation of random co-polymers that, when used in the heating step, can produce cross-linked co-polymers as described in the embodiments above. The method of the present technology allows for the formation of a random co-polymer prior to incorporation of the chromophore. Subsequent incorporation of the chromophore during the heating step may allow for the formation of a cross-linked co-polymer where the co-polymer is a random co-polymer and the chromophore is appropriately aligned for electro-optic activity.

In some embodiments, the heating step may include de-blocking the co-polymer to form a de-blocked co-polymer and the G-H, and reacting the cross-linker with the de-blocked co-polymer. Where R² is H; the de-blocked co-polymer is represented as

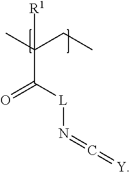

In such embodiments, the cross-linker may react with the de-blocked co-polymer during the heating step. In such embodiments, G-H may be removed during the heating step by evaporation, sublimation, or a combination thereof.

The present technology, thus generally described, will be understood more readily by reference to the following examples, which are provided by way of illustration and are not intended to be limiting of the present technology.

### EXAMPLES

### Example 1

### Synthesis of a Blocked Monomer: 2-(3,4-dimethyl-1H-pyrazole-1-carboxamido)ethyl methacrylate

To a flask containing 2-isocyanatoethyl methacrylate (Sigma-Aldrich, Mo., USA) as a 1M solution in tetrahydrofuran (THF) at 0° C. is slowly added 0.99 equivalents of 3,4-dimethyl-1H-pyrazole, followed by warming to room temperature. The reaction is allowed to proceed to completion at room temperature, at which time the reaction is quenched with a 1M aqueous solution of NH₄Cl followed by addition of diethyl ether and separation of the organic and aqueous layers by a separatory funnel. The organic layer is washed two times with a 1M aqueous solution of NH₄Cl, followed by washing with a brine solution. The organic layer is then dried over MgSO₄, filtered and the organic solvent removed by vacuum to provide 2-(3,4-dimethyl-1H-pyrazole-1-carboxamido)ethyl methacrylate.

### Example 2

### Generating a Random Co-Polymer with 2-(3,4-dimethyl-1H-pyrazole-1-carboxamido)ethyl Methacrylate and Methyl Acrylate

Methyl methacrylate (100 g; 1.00 mol) and 2-(3,4-dimethyl-1H-pyrazole-1-carboxamido)ethyl methacrylate (100 g; 0.40 mol) are dissolved in 500 milliliters (mL) of anhydrous benzene. The solution is vigorously purged with argon, followed by addition of azobisisobutyronitrile (AIBN) (4.0 g; 0.02 mol). The solution is then heated to 75° C. for 24 hours. The polymer solution is then cooled to room temperature, and the polymer precipitated in hexanes. The precipitate is filtered and dried under vacuum to yield a white powder.

### Example 3

### Alternative Procedure for Generating a Random Co-Polymer with 2-(3,4-dimethyl-1H-pyrazole-1-carboxamido)ethyl Methacrylate and Methyl Acrylate

Methyl methacrylate (100 g; 1.00 mol) and 2-(3,4-dimethyl-1H-pyrazole-1-carboxamido)ethyl methacrylate (100 g; 0.40 mol) are dissolved in 500 mL of anhydrous benzene. The solution is vigorously purged with argon followed by the sequential addition of AIBN (4.0 g; 0.02 mol) and butyl mercaptan (0.25 g; 0.0028 mol). The solution is then heated to 75° C. for 24 hours. The polymer solution is then cooled to room temperature, and the polymer precipitated in hexanes. The precipitate is filtered and dried under vacuum to yield a white powder.

### Example 4

### Generation of a Cross-Linked Co-Polymer with Electro-Optic Activity By Direct Poling

The co-polymer of Example 2 and 2-(3-cyano-44(E)-2-(5-((E)-4-((2-hydroxyethyl)(methyl)amino)styrypthiophen-2-yl)vinyl)-5-(4-(hydroxymethyl)phenyl)-5-(trifluoromethyl)furan-2(5H)-ylidene)malononitrile (“cross-linker A”; shown in Scheme 1) are blended in a ratio of 4 equivalents co-polymer to 1 equivalent cross-linker A in a small amount of cyclopentanone to produce a film forming solution.

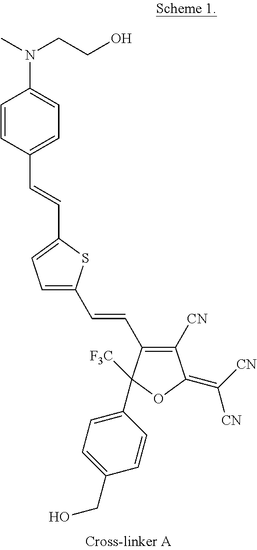 [SMILES: CN(CCO)c1ccc(/C=C/c2ccc(/C=C/C3=C(C#N)C(=C(C#N)C#N)OC3(c3ccc(CO)cc3)C(F)(F)F)s2)cc1]

The solution is then introduced by capillary action into a 5 μm gap between two glass slides with a transparent electrically conductive coating of indium tin oxide (ITO) on the inner surfaces. The gap, and therefore the resin thickness, was controlled by spacers around the boundaries of the slides. This assembly is heated to 130° C. and concurrently poled by direct DC contact poling at 120 V/μm through applying a voltage between the two ITO electrodes. This proceeds for 2 hours, whereupon cooling the assembly to room temperature and subsequently removing the electric field provides the cross-linked co-polymer with electro-optic activity. The electro-optic activity is measured according to published procedures [Teng, C. C.; Man, H. T. Appl. Phys. Lett. 1990, 56, 1734-1736]. Upon incorporation into an optoelectronic device, the cross-linked co-polymer with electro-optic activity is expected to have a bandwidth of greater than 10 GHz.

### Example 5

### Generation of a Cross-Linked Co-Polymer with Electro-Optic Activity By Corona Discharge

The co-polymer of Example 3 and cross-linker A are blended in a ratio of 3 equivalents co-polymer to 1 equivalent cross-linker A in a small amount of cyclopentanone to produce a film forming solution. Films of about 4 ₗam thickness are spin coated on 1.5 mm thick ITO coated glass substrate. Precise control of film thickness may be achieved by varying the relative concentrations in the cyclopentanone solution and by varying the spin speed. The cyclopentanone is removed via vacuum, and the free side of the film placed on a 1 mm thick fused silica sheet. The fused silica sheet side of the assembly is then placed on a hotplate in a dry argon atmosphere.

The conductive ITO coating between the glass substrate and the film is electrically connected to earth via a 10 MΩ current-limiting resistor. A steel needle is connected to the positive terminal of a high voltage supply and is centered over the sample, with the point a distance of 28 mm over the ITO-coated substrate surface. The voltage applied to the needle is set at 15 kV and the temperature of the hotplate is raised to 150° C. over a period of 4 minutes. The hotplate is then held at about 150° C. and the voltage applied to the needle held at 15 kV for 1 hour. Cooling the hotplate to room temperature, followed by removing the voltage applied to the needle supplies the cross-linked co-polymer with electro-optic activity. The electro-optic activity is measured according to published procedures [Teng, C. C.; Man, H. T. Appl. Phys. Lett. 1990, 56, 1734-1736]. Upon incorporation into an optoelectronic device, the cross-linked co-polymer with electro-optic activity is expected to have a bandwidth of greater than 10 GHz.

### Example 6

### Synthesis of a Different Blocked Monomer: Dimethyl 2-((2-(methacryloyloxy)ethyl)carbamoyl)malonate

A 0.1 M solution of dimethyl malonate in dry THF is added to a flask under an argon atmosphere and containing a magnetic stirrer. The mixture is cooled to −20° C. 0.99 equivalents of dry NaH is added in an argon atmosphere over 15 minutes to the dimethyl malonate solution with continuous stirring. The reaction is allowed to proceed for 30 minutes at −20° C. The deprotonated dimethyl malonate solution is then slowly transferred via cannula to a flask containing 0.99 equivalents a 1M THF solution of 2-isocyanatoethyl methacrylate (Sigma-Aldrich, Mo., USA) held at −20° C. with stirring. The reaction is allowed to proceed at −20° C. for 30 minutes, followed by warming to room temperature. Upon completion the reaction is quenched with a 1M solution of NaHCO₃ immediately followed by addition of diethyl ether and separation of the organic and aqueous layers by a separatory funnel. The organic layer is washed two times with a 1M solution of NaHCO₃, followed by washing with a brine solution. The organic layer is then dried over MgSO₄, filtered, and the organic solvent removed to provide dimethyl 2-((2-(methacryloyloxy)ethyl)carbamoyl)malonate.

### Example 7

### Alternative Procedure for the Synthesis of Dimethyl 2-((2-(methacryloyloxy)ethyl)carbamoyl)malonate

To 100 mL of a 0.1 M solution of dimethyl malonate (10 mol) in dry THF in a flask under an argon atmosphere and containing a magnetic stirrer is added triethylamine (1.0 g, 9.9 mmol) with continuous stirring. 99 mL of a THF solution of 2-isocyanatoethyl methacrylate (0.1 M; 9.9 mol) is then added drop wise to the dimethyl malonate solution. The reaction is allowed to proceed until completion. Upon completion, the reaction is quenched with a 1M solution of NaHCO₃, immediately followed by addition of diethyl ether and separation of the organic and aqueous layers by a separatory funnel. The organic layer is washed two times with a 1M solution of NaHCO₃, followed by washing with a brine solution. The organic layer is then dried over MgSO₄, filtered, and the organic solvent removed to provide dimethyl 2-((2-(methacryloyloxy)ethyl)carbamoyl)malonate.

### Example 8

### Generation of a Random Co-Polymer with the Blocked Monomer Dimethyl 2-((2-(methacryloyloxy)ethyl)carbamoyl)malonate

1-adamantyl methacrylate (200 g; 0.91 mol) and dimethyl 2-((2-(methacryloyloxy)ethyl)carbamoyl)malonate (100 g;0.35 mol) are dissolved in 700 mL of anhydrous benzene. The solution is vigorously purged with argon and AIBN (5.0 g; 0.03 mol) is added. The solution is heated to 75° C. for 24 hours. The polymer solution is then cooled to room temperature, and the polymer precipitated in hexanes. The precipitate is filtered and dried under vacuum to yield a white powder.

### Example 9

### Alternative Procedure for Generating a Random Co-Polymer with the Blocked Monomer Dimethyl 2-((2-(methacryloyloxy)ethyl)carbamoyl)malonate

1-adamantyl methacrylate (200 g; 0.91 mol) and dimethyl 2-((2-(methacryloyloxy)ethyl)carbamoyl)malonate (100 g; 0.35 mol) are dissolved in 700 mL of anhydrous benzene. The solution is vigorously purged with argon and AIBN (5.0 g; 0.03 mol) and butyl mercaptan (0.5 g; 0.0055 mol) are sequentially added. The solution is then heated to 75° C. for 24 hours. The polymer solution is then cooled to room temperature, and the polymer precipitated in hexanes. The precipitate is filtered and dried under vacuum to yield a white powder.

### Example 10

### Generation of a Cross-Linked Co-Polymer with Electro-Optic Activity Utilizing Direct Poling and the Co-Polymer of Example 6

A cross-linked co-polymer with electro-optic activity generated from the co-polymer of Example 9 and 2,5-bis((E)-4-((2-hydroxyethyl)(methyl)amino)styryl)terephthalonitrile (“cross-linker B”; shown in Scheme 2) is achieved via the direct poling method described in Example 4, with the poling at 250 V/μm and the temperature at 200° C. Upon incorporation into an optoelectronic device, the cross-linked co-polymer with electro-optic activity is expected to have a bandwidth of greater than 10 GHz.

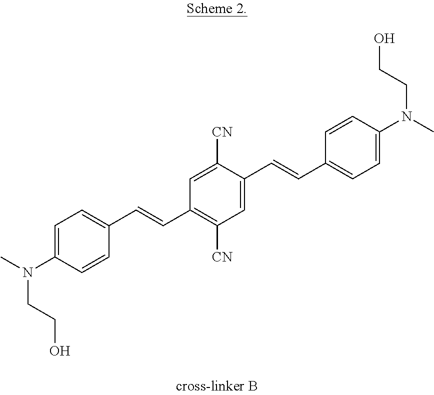

### Example 11

### Generation of a Cross-Linked Co-Polymer with Electro-Optic Activity Utilizing Corona Discharge and the Co-Polymer of Example 6

A cross-linked co-polymer with electro-optic activity generated from the co-polymer of Example 8 cross-linker B is achieved via the corona discharge method described in Example 5, with the corona voltage at +30 kV and the temperature at 200° C. Upon incorporation into an optoelectronic device, the cross-linked co-polymer with electro-optic activity is expected to have a bandwidth of greater than 10 GHz.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A cross-linked co-polymer comprising a first repeating unit and a second repeating unit, wherein the first repeating unit is represented as 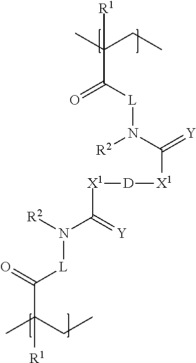
wherein:
X¹ is O, NR³, or S;
Y is O or S;
R¹ is H, alkyl, cyano, or halo;
R² is H, alkyl, or aryl;
R³ is H or alkyl;
L is —alkylene-, —O-alkylene-, —NR⁴-alkylene-, -heterocyclylene-, —O-heterocyclylene-, —NR⁴-heterocyclylene-, -arylene-, —O-arylene-, —NR⁴-arylene-, -heteroarylene-, —O-heteroarylene-, or —NR⁴-heteroarylene-; where R⁴ is H, alkyl, or aryl; and
D is a chromophore represented by one of the following formulas: 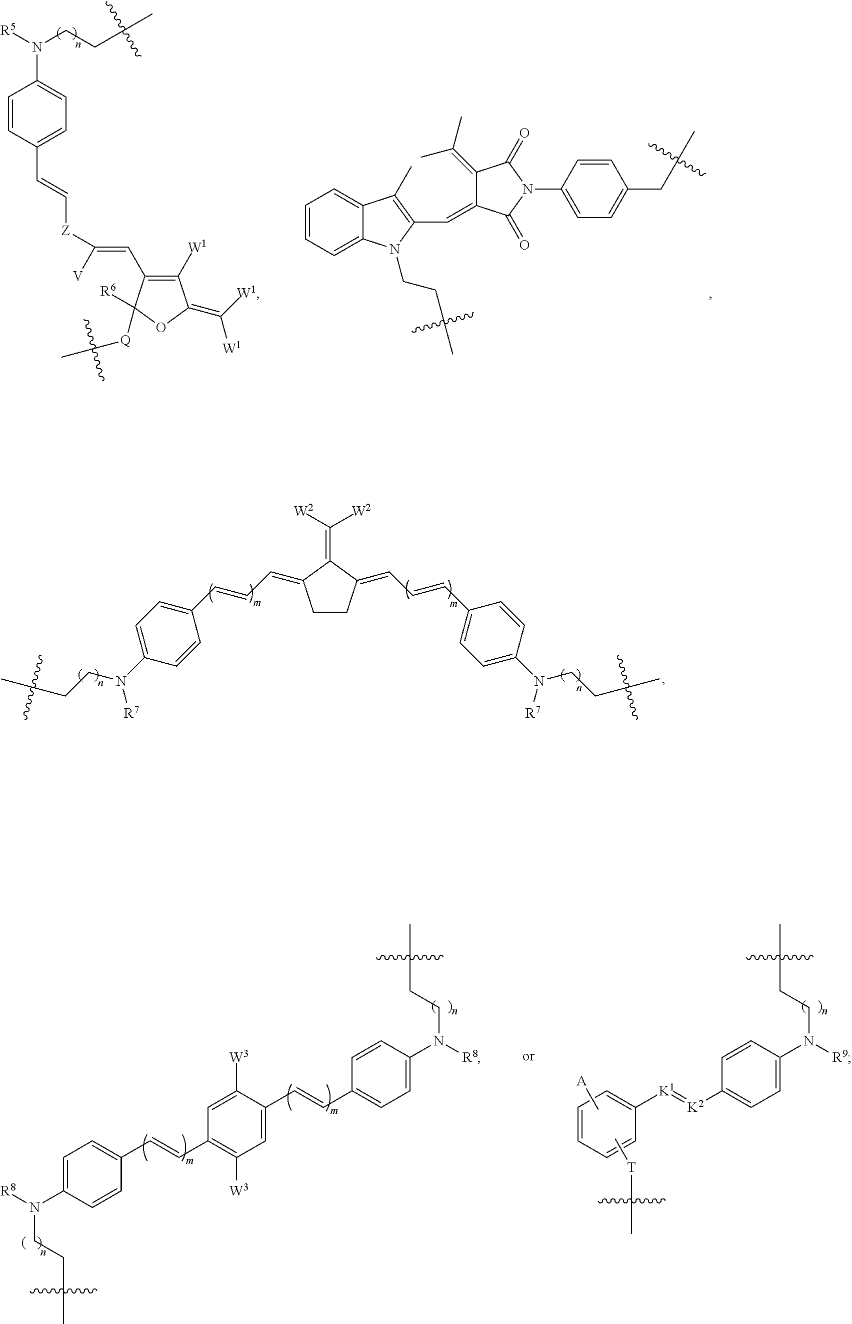
where
R⁵, R⁷, R⁸ and R⁹ are each independently alkyl or aryl;
R⁶ is alkyl, perhaloalkyl, aryl, or aralkyl;
Z is alkenylene, arylene, or heteroarylene;
V is H or an alkylene group bonded to Z;
Q is alkylene, arylene, or aralkylene;
K¹ and K² are each independently CH or N;
T is alkylene or arylene, and T is in an ortho or a meta position on the ring with respect to the bond to K;
A is cyano, nitro, CF₃ or 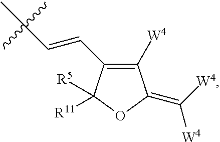
where R¹¹ is alkyl, perhaloalkyl, aryl, or aralkyl, and A is in a para or an ortho position on the ring with respect to the bond to K¹;
W¹W², W³, and W⁴ are each independently cyano, perhaloalkyl, CO₂R¹⁰ SO₂R¹⁰, S(O)(OR¹⁰)₂, P(O)(OR¹⁰)₂;
W³ is independently perhaloalkyl, CO₂R¹⁰, SO₂R¹⁰, S(O)(OR¹⁰)₂, P(O)(OR¹⁰)₂;
R¹⁰ is alkyl or perhaloalkyl,
n is 1, 2, 3, 4, 5, 6, 7, 8, 10, or 11, and
m is 1, 2, 3, or 4.

2.-3. (canceled)

4. The cross-linked co-polymer of claim 1, wherein L is —O-ethylene-, —O-propylene-, or —O-butylene-.

5. The cross-linked co-polymer of claim 1, wherein the second repeating unit is derived from a styrenic monomer, a acrylate monomer, a cyanoacrylate monomer, an acrylamide monomer, or an olefinic monomer.

6.-8. (canceled)

9. The cross-linked co-polymer of claim 1, wherein X¹ is O.

10.-11. (canceled)

12. The cross-linked co-polymer of claim 1, wherein T is in a meta position with respect to the bond to K¹.

13. The cross-linked co-polymer of claim 1, wherein K² is CH.

14. The cross-linked co-polymer of claim 1, wherein K¹ and K² are both N.

15. The cross-linked co-polymer of claim 1, wherein n is 1, 2, 3, or 4.

16. The cross-linked co-polymer of claim 1, wherein R⁵, R⁷, R⁸ and R⁹ are each independently alkyl.

17. The cross-linked co-polymer of claim 1, wherein R⁶ is methyl, CF₃, or p-methoxyphenyl.

18. The cross-linked co-polymer of claim 1, wherein Q is —CH₂-Ph-.

19. The cross-linked co-polymer of claim 1, wherein R¹¹ is methyl, CF₃, or p-methoxyphenyl.

20. The cross-linked co-polymer of claim 1, wherein W¹, W², W³, and W⁴ are each independently cyano, CF₃, CF₂CF₃, CO₂Me, CO₂Et, SO₂CF₃, SO₂Ph, S(O)(OPhCH₃)₂, P(O)(OCH₃)₂, P(O)(OCF₃)₂, P(O)(OPh)₂, or P(O)(OPhCH₃)₂.

21. The cross-linked co-polymer of claim 1, wherein
R⁹ is Cₗ-C₆ alkyl;
K¹ and K² are both N;
A is p-cyano, p-nitro, or p-CF₃;
T is methylene, ethylene, propylene, or butylene; and
n is 1, 2, 3, or 4.

22. The cross-linked co-polymer of claim 1, wherein the chromophore is

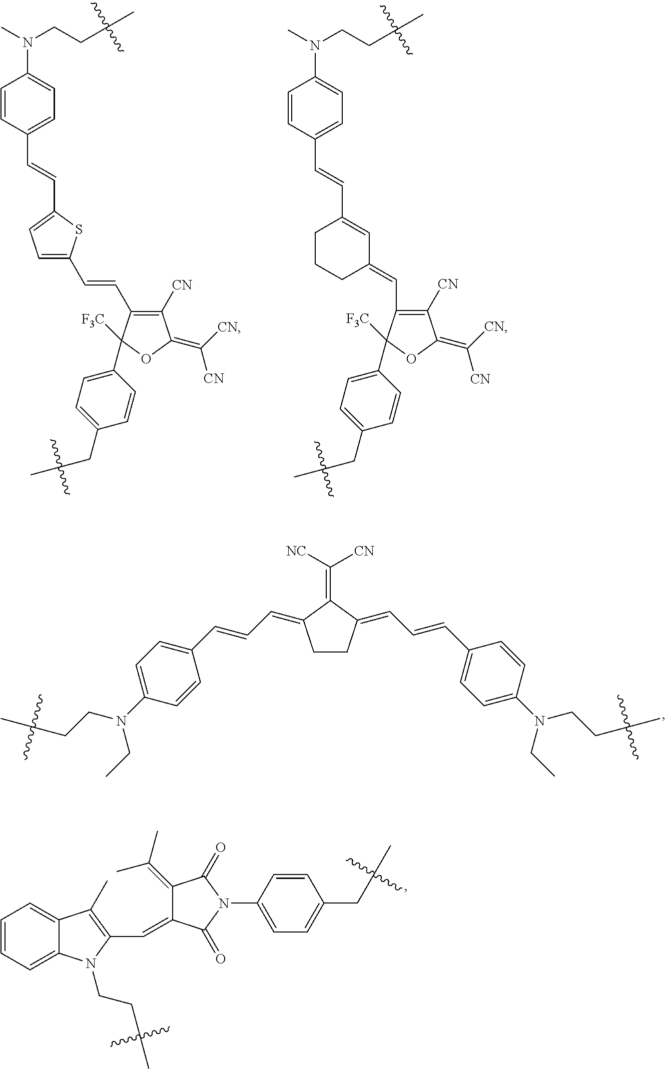 [SMILES: *CCN(C)c1ccc(/C=C/c2ccc(/C=C/C3=C(C#N)C(=C(C#N)C#N)OC3(c3ccc(C*)cc3)C(F)(F)F)s2)cc1 ; *CCN(C)c1ccc(/C=C/C2=CC(=C/C3=C(C#N)C(=C(C#N)C#N)OC3(c3ccc(C*)cc3)C(F)(F)F)/CCC2)cc1 ; *CCN(CC)c1ccc(/C=C/C=C2\CC/C(=C\C=C\c3ccc(N(CC)CC*)cc3)C2=C(C#N)C#N)cc1 ; *CCn1c(/C=C2/C(=O)N(c3ccc(C*)cc3)C(=O)C2=C(C)C)c(C)c2ccccc21]

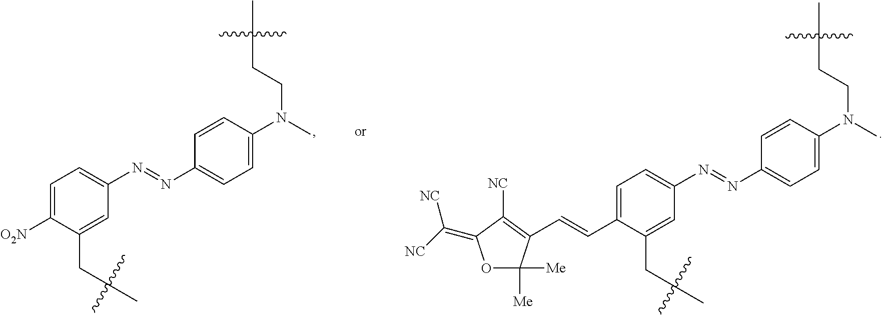 [SMILES: *CCN(C)c1ccc(/N=N/c2ccc([N+](=O)[O-])c(C*)c2)cc1 ; *CCN(C)c1ccc(/N=N/c2ccc(/C=C/C3=C(C#N)C(=C(C#N)C#N)OC3(C)C)c(C*)c2)cc1]

23. An optoelectronic device comprising
a cross-linked co-polymer of claim 1, comprising a first and a second end; and
a light source proximal to the first end of the co-polymer configured to illuminate light onto the first end such that the light propagates from the first end to the second end;
wherein
the optoelectronic device has a bandwidth of about 1 GHz to about 10 THz.

24. The optoelectronic device of claim 23, wherein
a portion of the cross-linked co-polymer is split into a first branch and a second branch and subsequently rejoined;
a portion of the first branch is attached to two electrodes that span the diameter of the first branch.

25.-45. (canceled)

46. A method of producing a cross-linked co-polymer, comprising
heating a film comprising a co-polymer and a cross-linker in the presence of an electric field;
wherein
the co-polymer comprises a first repeating unit and a second repeating unit, where the first repeating unit is represented as
where 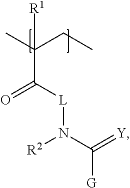
Y is Y or S;
R¹ is H, alkyl, cyano, or halo;
R² is H, alkyl, or aryl;
L is a linking moiety; and
G is an O- or N-bound blocking group;
the cross-linker is represented as
X²-D-X²
where
X² is OH, NHR³, or SH;
R³ is H or alkyl;
D is a chromophore, each X² is separated from the other by at least 10 atoms in the chromophore and at least two of the 10 atoms are part of a conjugated 7c-electron system; and
heating the co-polymer with the cross-linker in the presence of the electric field generates G-H, wherein G-H is an alkyl alcohol, an aryl alcohol, an imidazole, a pyrazole, a triazole, a tetrazole, an imide, a 62 dicarbonyl compound, a β-cyano carbonyl compound, a pyrrolidine, a morpholine, a thiomorpholine, a pyridine, a piperidine, or a combination of any two or more thereof.

47.-64. (canceled)

65. The method of claim 46, wherein the electric field is applied by a contact poling or a corona discharge.

66.-83. (canceled)

84. The method of claim 46, wherein G-H is removed during the heating step by evaporation, sublimation, or a combination thereof.

85.-87. (canceled)
